(19) United States
(12) Patent Application Publication
(10) Pub. No.: US 2008/0225240 A1
(43) Pub. Date: Sep. 18, 2008

(54) PROJECTION SYSTEM AND PLASTIC COLOR WHEEL ASSEMBLY THEREOF

(76) Inventors: Kuang-Hua CHANG, Taipei (TW); Chong-Han Tsai, Taipei County (TW); Kai-Hsiung Tsao, Taipei (TW); Ke-Shu Chin, Taipei County (TW); Chih-Huang Wang, Taipei County (TW); Shiau-Wu Lai, Taipei County (TW); Guang-Yu Yu, Taipei County (TW)

Correspondence Address: BIRCH STEWART KOLASCH & BIRCH, PO BOX 747, FALLS CHURCH, VA, 22040-0747, US

(21) Appl. No.: 11/952,778

(22) Filed: Dec. 7, 2007

(30) Foreign Application Priority Data
Mar. 12, 2007 (TW) 096108421

(51) Int. Cl. G03B 21/14; G02B 5/22

(52) U.S. Cl. 353/84; 359/891

(57) ABSTRACT

A plastic color wheel assembly includes a motor and a color filtering plate. The color filtering plate is disposed at one side of the motor and is made of plastic A projection system including the plastic color wheel is also disclosed.

### CROSS REFERENCE TO RELATED APPLICATIONS

This Non-provisional application claims priority under 35 U.S.C. §119(a) on Patent Application No(s). 096108421 filed in Taiwan, Republic of China on Mar. 12, 2007, the entire contents of which are hereby incorporated by reference.

### BACKGROUND OF THE INVENTION

1. Field of Invention

The invention relates to a projection system and a color wheel assembly thereof, and, in particular, to a projection system and a plastic color wheel assembly thereof.

2. Related Art

With the progress of the technology, the stoppage of the large-size flat panel display product has been gradually overcome, and the large-size flat panel display products have gradually entered the home market. The projection technology has been gradually in favor with the users because it can provide a larger scale and a much more shocked visual effect. Among various projecting devices, a digital light source processor (DLP) can attract the attentions of users because it has the advantages of high brightness, short response time, no noise and compact size so that the DLP has become the mainstream technology of the projecting device.

The DLP projection system has the digital control and works according to the principle of light reflection. A light beam is collected and then focused by a lens, and then passes through a color filtering plate having red, green and blue filters. Then, the light beam is projected onto a digital micro-mirror device (DMD). In this technology, the DMD has been used to replace a liquid crystal display panel for representing the image in a conventional liquid crystal projecting system. The DMD has many rotatable micro-mirrors having tilt angles and deflection times, which are driven and controlled. Accordingly, the reflection direction of the light beam is switched so that the light beam is projected via the projection lens.

FIGS. 1A and 1B are cross-sectional side views showing a color wheel assembly 1 for splitting a light beam in a conventional DLP projector. The color wheel assembly 1 mainly includes a motor 11, a color filtering plate 12, a covering sheet 13 and a positioning part 14. The motor 11 is disposed on the positioning part 14, and the covering sheet 13 and the color filtering plate 12 are fixed on the motor 11. The motor 11 is mainly composed of a shaft cover 111, a motor body 112 and a motor casing 113. The motor body 112 has a rotating shaft 1121 axially mounted on the shaft cover 111. The covering sheet 13 may be disposed on the color filtering plate 12, as shown in FIG. 1A, or disposed between the motor 11 and the color filtering plate 12, as shown in FIG. 1B.

The color filtering plate 12 is usually made of a glass plate coated with different color films, or composed of several glass plates, which are coated with different colors. The color filtering plate 12 can be an annular filter composed of a red filter, a green filter and a blue filter. Alternatively, the color filtering plate 12 may also be an annular filter composed of several red sections, green sections and blue sections, or composed of several red sections, green sections, blue sections and transparent sections.

As mentioned hereinabove, the conventional color wheel assembly has the color filtering plate made of the glass plate. The color filtering plate may be damaged and thus has to be replaced if it is not properly used, thereby bringing the inconvenience to the user and increasing the cost. In addition, the cost of the glass material is also higher.

Therefore, it is an important subject of the invention to provide a projection system and a color wheel assembly thereof that cannot be easily damaged and have lower material costs.

### SUMMARY OF THE INVENTION

In view of the foregoing, the invention is to provide a projection system and a plastic color wheel assembly thereof, which cannot be easily damaged and have lower material costs.

To achieve the above, the invention discloses a plastic color wheel assembly, which includes a motor and a color filtering plate. The color filtering plate is disposed at one side of the motor and made of plastic.

To achieve the above, the invention also discloses a projection system, which includes a light source, a plastic color wheel assembly and a projection lens. The plastic color wheel assembly is disposed at one side of the light source and includes a motor and a color filtering plate. The color filtering plate is disposed at one side of the motor and is made of plastic. The projection lens is disposed at the other side of the plastic color wheel assembly.

As mentioned above, the projection system and plastic color wheel assembly thereof according to the invention have the color filtering plate made of plastic. Compared with the related art, the plastic has the advantages that it can be easily dyed and molded and cannot be easily damaged. Thus, it is possible to prevent the damage of the color filtering plate due to the carelessly use of the projection system. In addition, the material cost of the plastic is lower than that of the glass so that the manufacturing cost of the projection system and plastic color wheel assembly of the invention can be reduced and the product cannot be easily damaged. Moreover, the plastic color wheel assembly of the invention may further have a washer, and the color filtering plate is mounted around the washer so as to firmly fix the color filtering plate. In addition, the plastic color wheel assembly of the invention may further have an annular outer frame, which is mounted around the color filtering plate to reinforce the combination between the color filtering plate and the washer.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a cross-sectional side view showing a conventional color wheel assembly;

FIG. 1B is a cross-sectional side view showing another conventional color wheel assembly;

FIG. 2 is a schematic illustration showing a projection system according to a preferred embodiment of the invention;

FIG. 3A is a schematic illustration showing a color filtering plate and a washer according to the preferred embodiment of the invention;

FIG. 3B is a schematically exploded view showing the color filtering plate and the washer of FIG. 3A;

FIG. 3C is another schematically exploded view showing the color filtering plate and washer according to the preferred embodiment of the invention;

FIGS. 4A and 4B are schematic illustrations showing another color filtering plate and washer according to the preferred embodiment of the invention;

FIG. 4C is a cross-sectional side view showing a plastic color wheel assembly of FIG. 4A;

FIG. 5 is a cross-sectional side view showing another plastic color wheel assembly according to the preferred embodiment of the invention; and

FIG. 6 is a schematic illustration showing still another plastic color wheel assembly according to the preferred embodiment of the invention.

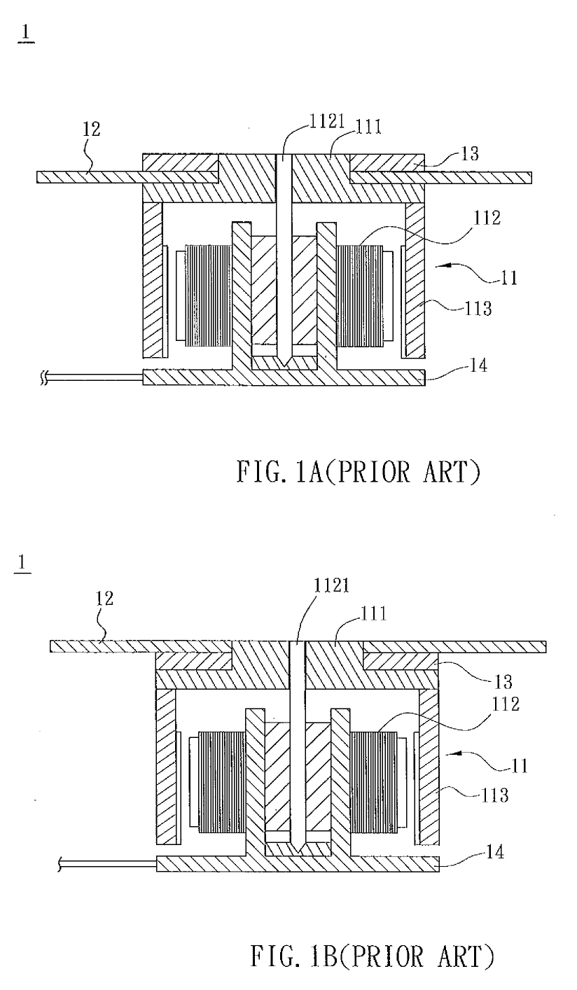

### DETAILED DESCRIPTION OF THE INVENTION

The present invention will be apparent from the following detailed description, which proceeds with reference to the accompanying drawings, wherein the same references relate to the same elements.

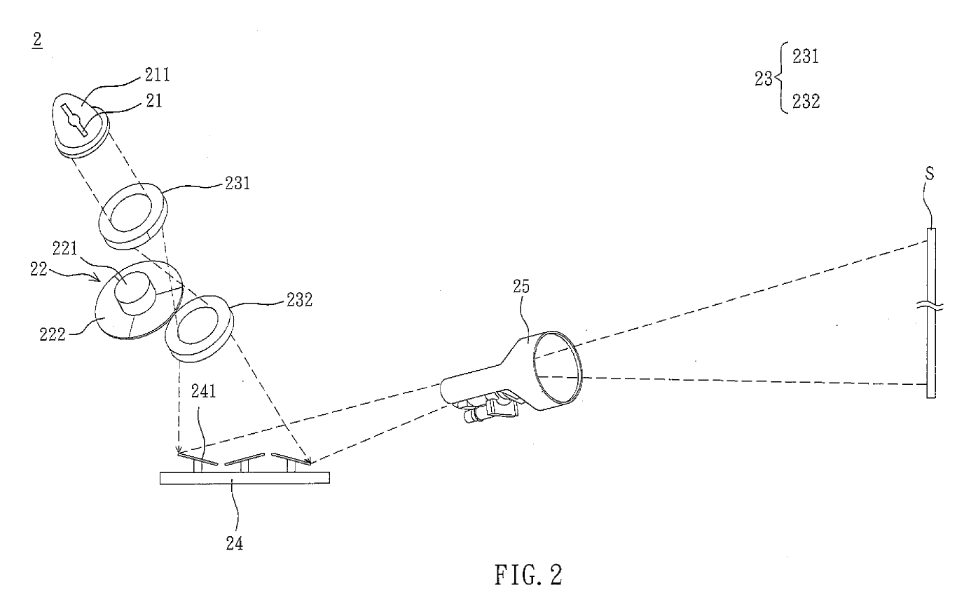

FIG. 2 is a schematic illustration showing a projection system 2 according to a preferred embodiment of the invention. In this embodiment, the projection system 2 is a DLP projection system, for example. The projection system 2 includes a light source 21, a plastic color wheel assembly 22, a projection lens 23, a digital micro-mirror device (DMD) 24 and a projection lens 25.

As mentioned hereinabove, the light source 21 is disposed in a lampshade 211, and outputs a light beam. The projection lens 23 has a first lens 231 for focusing the light beam, and the focused light beam then passes through the plastic color wheel assembly 22 having a color filtering plate 222 so that the light beam is split into red, blue and green light beams. Then, a second lens 232 of the projection lens 23 diverges the light beams onto the DMD 24. The plastic color wheel assembly 22 is disposed at one side of the DMD 24. Each memory (not shown) corresponding to the pixel on the DMD 24 records a digital value of a signal of the corresponding pixel, and transmits the signal to a driving electrode (not shown) to control a deflection angle and a control deflection time for a micro reflecting mirror 241. The deflected reflecting mirrors 241 of the DMD 24 reflect the incident light beams at different angles, and the generated reflected light beams are projected onto a screen S via the projection lens 25 disposed at the other side of the DMD 24.

Referring again to FIG. 2, the plastic color wheel assembly 22 according to the preferred embodiment includes a motor 221 and the color filtering plate 222. The plastic color wheel assembly 22 is a beam splitter applied to the DLP projection system 2.

The motor 221 has a body and a casing. The body of the motor 221 is mainly composed of a rotating shaft, a magnetic ring, a silicon steel sheet and a coil. When the coil is applied with current, the silicon steel sheet generates a magnetic force and a magnetic field. The positive/negative polarity and intensity of the current are controlled to make the magnetic field change in order so that a rotating magnetic field is generated. Then, the magnetic ring cooperates with the rotating magnetic field and the rotating shaft is thus rotated. In addition, the color filtering plate 222 is directly disposed on the motor 221. For example, the color filtering plate 222 is adhered to the casing of the motor 221. The rotation of the rotating shaft of the motor 221 can cause the rotation of the color filtering plate 222.

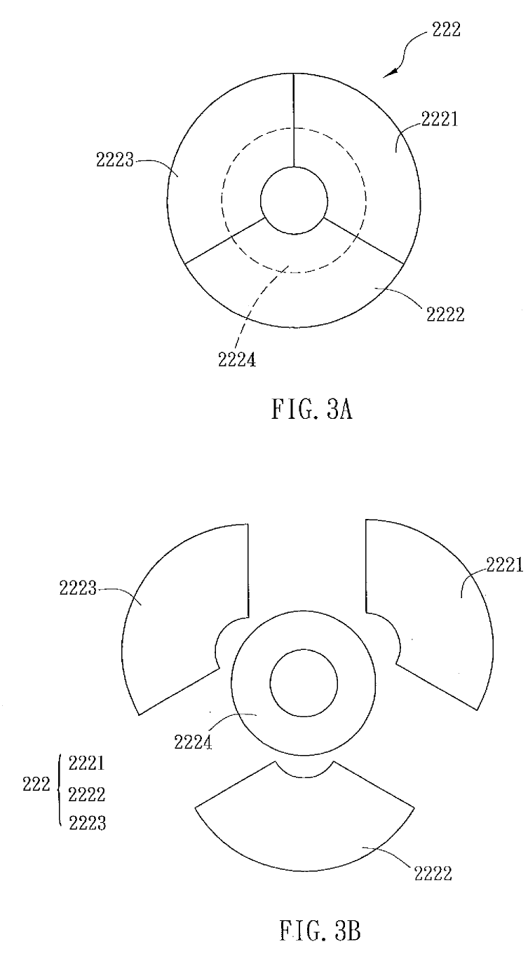

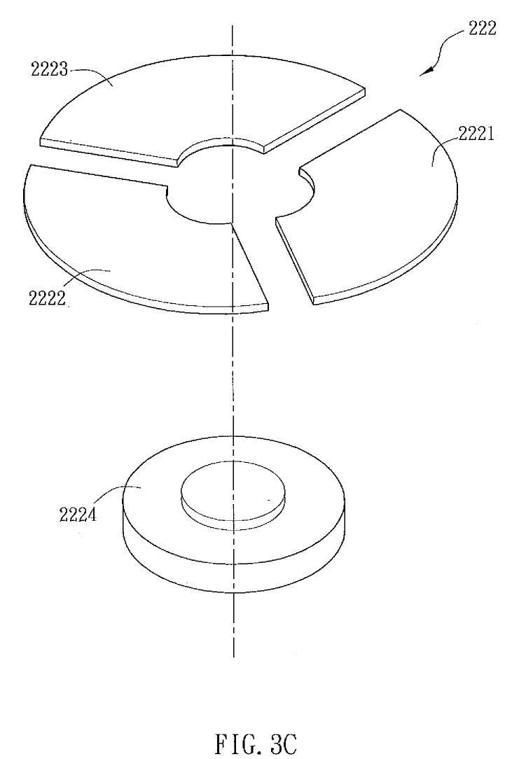

FIG. 3A is a schematic illustration showing the color filtering plate 222 and a washer 2224 according to the preferred embodiment of the invention. FIG. 3B is a schematically exploded view showing the color filtering plate 222 and the washer 2224 of FIG. 3A. FIG. 3C is another schematically exploded view showing the color filtering plate 222 and the washer 2224 according to the preferred embodiment of the invention. Herein, the color filtering plate 222 includes a plurality of plastic plates respectively doped with pigment of different colors. For example, the color filtering plate 222 has a red plastic plate 2221 doped with red pigment, a green plastic plate 2222 doped with green pigment, and a blue plastic plate 2223 doped with blue pigment.

In addition, a surface of the color filtering plate 222 may have a plurality of filtering films to form a red filtering film, a green filtering film and a blue filtering film. The filtering film may also a coloring film with different colors. Alternatively, the filtering film may also be a color heat-cured adhesive film or a sputtered film. The material of the color heat-cured adhesive film may be the compound of ethylene vinyl acetate (EVA) doped with pigment of different colors to form a color film so that the surface of each plastic plate has different colors. In addition, the color of the color filtering plate 222 or the color of the filtering film is not restricted to the red, green and blue colors. Instead, any colors capable of serving as the beam splitting bases are deemed as falling within the scope of the invention. In addition, the plastic plates 2221 to 2223 may be formed by way of injection molding, and the material of each of the plastic plates 2221 to 2223 may be polycarbonate (PC), polymethyl methacrylate (P glass reinforced plastic (GRP) or fiber reinforced plastic (FRP).

As mentioned hereinabove, the plastic color wheel assembly 22 may further have the washer 2224. Each of the plastic plates 2221 to 2223 has a fan shape, and the plastic plates 2221 to 2223 are arranged to constitute a circular shape or an annular shape (as shown in FIGS. 3A to 3C). The plastic plates 2221 to 2223 are mounted around an outer periphery of the washer 2224 so that the plastic plates 2221 to 2223 can be firmly fixed to the washer 2224 to form the color filtering plate 222. The washer 2224 may be an annular washer, as shown in FIG. 3B, a circular washer, or a circular washer having a projection, as shown in FIG. 3C. In addition, each of the plastic plates 2221 to 2223 and the washer 2224 may be combined together by way of adhering, hot welding, embedding or engaging. The material of the washer 2224 is not particularly restricted, and may be glass, metal (e.g., copper), a ceramic material or plastic.

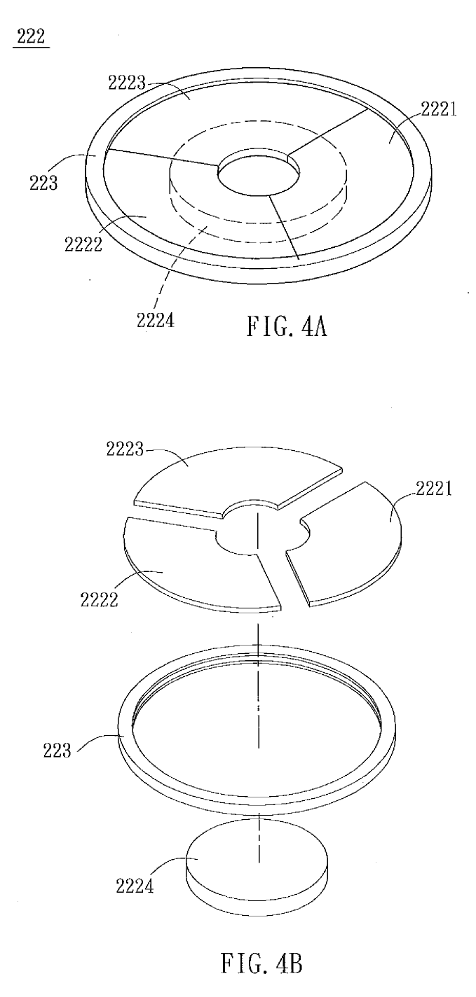

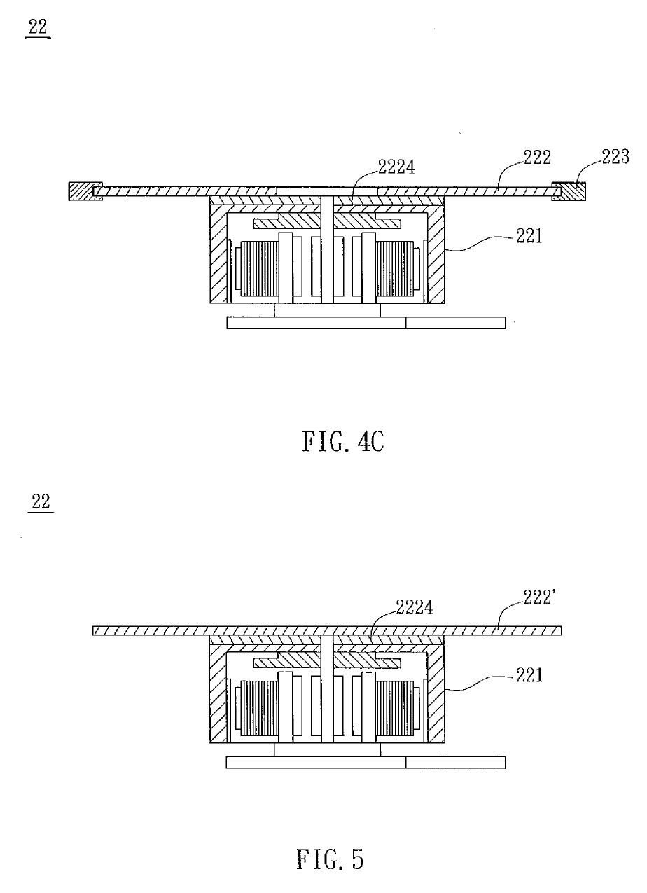

FIG. 4A is a schematic illustration showing another color filtering plate 222 and washer 2224 according to the preferred embodiment of the invention. FIG. 4B is a schematically exploded view of FIG. 4A. FIG. 4C is a schematic illustration showing a plastic color wheel assembly 22 of FIG. 4A disposed in a motor 221. Referring to FIGS. 4A to 4C, the plastic color wheel assembly 22 of this embodiment further includes an annular outer frame 223 mounted around the color filtering plate 222 by way of adhering, hot welding, embedding or engaging to reinforce the structure intensity of the color filtering plate 222. The material of the annular outer frame 223 is not particularly restricted, and may be glass, metal (e.g., copper), a ceramic material, plastic or combinations thereof. For example, a metal sheet (or metal wire) may be circled and then embedded into a frame body to reinforce the structure of the color filtering plate 222 by the strength of the metal sheet (metal wire). In addition, when the annular outer frame 223 is made of the plastic, it may also be formed by way of injection molding.

FIG. 5 is a cross-sectional side view showing another plastic color wheel assembly 22 according to the preferred embodiment of the invention. As shown in FIG. 5, the color filtering plate 222′ is a plastic circular plate disposed on the motor 221. In this embodiment, the motor 221 of FIG. 5 is the same as those mentioned hereinabove, and the function, structure and arrangement relationship of the motor 221 have been described hereinabove, so detailed descriptions thereof will be omitted.

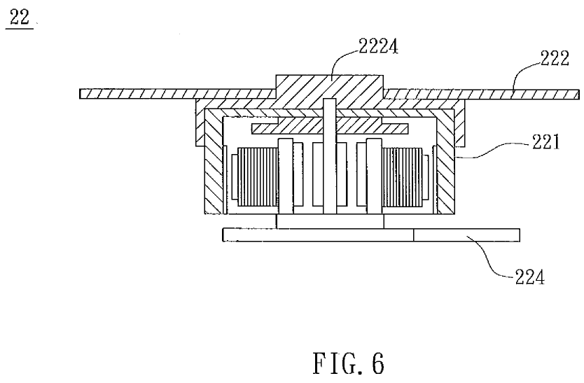

FIG. 6 is a schematic illustration showing still another plastic color wheel assembly 22 according to the preferred embodiment of the invention. As shown in FIG. 6, the washer 2224 of the color filtering plate 222 is a cap-like washer and covers the motor 221. The combination area between the washer 2224 and the motor 221 is enlarged to assist in tightly combining the color filtering plate 222 with the motor 221.

In addition, the plastic color wheel assembly 22 may further include a positioning part 224, and the motor 221 is axially mounted on the positioning part 224.

In addition, the color filtering plate 222 of this embodiment may be composed of red, green and blue color films disposed between two plastic layers. The material of the color film is a color heat-cured adhesive film mentioned hereinabove, so detailed descriptions thereof will be omitted.

In summary, the projection system and plastic color wheel assembly thereof according to the invention have the color filtering plate made of plastic. Compared with the related art, the plastic has the advantages that it can be easily dyed and molded and cannot be easily damaged. Thus, it is possible to prevent the damage of the color filtering plate due to the carelessly use of the projection system. In addition, the material cost of the plastic is lower than that of the glass so that the manufacturing cost of the projection system and plastic color wheel assembly of the invention can be reduced and the product cannot be easily damaged. Moreover, the plastic color wheel assembly of the invention may further have a washer, and the color filtering plate is mounted around the washer so as to firmly fix the color filtering plate. In addition, the plastic color wheel assembly of the invention may further have an annular outer frame, which is mounted around the color filtering plate to reinforce the combination between the color filtering plate and the washer.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A plastic color wheel assembly, comprising:
a motor; and
a color filtering plate disposed at one side of the motor and made of plastic.

2. The plastic color wheel assembly according to claim 1, wherein the plastic is polycarbonate (PC), polymethyl methacrylate (PMMA), glass reinforced plastic (GRP) or fiber reinforced plastic (FRP).

3. The plastic color wheel assembly according to claim 1, wherein the color filtering plate further comprises a plurality of filtering films disposed on a surface of the color filtering plate, and each of the filtering films is a coloring film, a color heat-cured adhesive film or a sputtered film.

4. The plastic color wheel assembly according to claim 3, wherein a material of the color heat-cured adhesive film comprises ethylene vinyl acetate EVA).

5. The plastic color wheel assembly according to claim 1, wherein the color filtering plate is doped with pigment.

6. The plastic color wheel assembly according to claim 1, wherein the color filtering plate comprises a plurality of plastic plates.

7. The plastic color wheel assembly according to claim 6, wherein each of the plastic plates has a fan shape, and the plastic plates are arranged together to form a circular shape or an annular shape.

8. The plastic color wheel assembly according to claim 6, further comprising:
a washer, wherein the plastic plates are mounted around an outer periphery of the washer.

9. The plastic color wheel assembly according to claim 8, wherein the washer is an annular washer or a circular washer.

10. The plastic color wheel assembly according to claim 8, wherein the washer is a cap-like washer covering the motor.

11. The plastic color wheel assembly according to claim 8, wherein the plastic plates are combined with the washer by way of adhering or hot welding.

12. The plastic color wheel assembly according to claim 1, further comprising:
an annular outer frame disposed around the color filtering plate.

13. The plastic color wheel assembly according to claim 12, wherein the annular outer frame is combined with the color filtering plate by way of adhering or hot welding.

14. A projection system, comprising:
a light source;
a plastic color wheel assembly disposed at one side of the light source and having a motor and a color filtering plate, wherein the color filtering plate is disposed at one side of the motor and is made of plastic; and
a projection lens disposed at the other side of the plastic color wheel assembly.

15. The projection system according to claim 14, wherein the plastic is polycarbonate (PC), polymethyl methacrylate (PMMA), glass reinforced plastic (GRP) or fiber reinforced plastic (FRP).

16. The projection system according to claim 14, wherein the color filtering plate further comprises a plurality of filtering films disposed on a surface of the color filtering plate.

17. The projection system according to claim 16, wherein each of the filtering films is a coloring film, a color heat-cured adhesive film or a sputtered film.

18. The projection system according to claim 17, wherein a material of the color heat-cured adhesive film comprises ethylene vinyl acetate (EVA).

19. The projection system according to claim 14, wherein the color filtering plate is doped with pigment.

20. The projection system according to claim 14, wherein the color filtering plate comprises a plurality of plastic plates.

21. The projection system according to claim 20, wherein each of the plastic plates has a fan shape, and the plastic plates are arranged together to form a circular shape or an annular shape.

22. The projection system according to claim 20, wherein the plastic color wheel assembly further comprises:
a washer, wherein the plastic plates are mounted around an outer periphery of the washer.

23. The projection system according to claim 22, wherein the washer is an annular washer or a circular washer.

24. The projection system according to claim 22, wherein the washer is a cap-like washer covering the motor.

25. The projection system according to claim 22, wherein the plastic plates are combined with the washer by way of adhering or hot welding.

26. The projection system according to claim 14, wherein the plastic color wheel assembly further comprises:
an annular outer frame disposed around the color filtering plate.

27. The projection system according to claim 26, wherein the annular outer frame is combined with the color filtering plate by way of adhering or hot welding.
